(19) United States
(12) Patent Application Publication
(10) Pub. No.: US 2012/0272568 A1
(43) Pub. Date: Nov. 1, 2012

(54) Charcoal Manufacturing Process and Apparatus

(76) Inventors: Stephen David Joseph, Saratoga (AU); Tim Blake, Bowral (AU)

(21) Appl. No.: 13/508,331

(22) PCT Filed: Nov. 5, 2010
(86) PCT No.: PCT/AU10/01478

§ 371 Date: Jul. 13, 2012

(30) Foreign Application Priority Data
Nov. 6, 2009 (AU) 2009905416

(51) Int. Cl. C10L 5/44; B01J 19/18; B01J 19/00

(52) U.S. Cl. 44/500; 422/198; 422/187

(57) ABSTRACT

The invention provides a continuous charcoal manufacturing apparatus for turning particulate organic material into charcoal. The apparatus comprises a source of the particulate organic material, a retort and a heating device for heating gas in an external vessel interior space. The source of the particulate organic material comprises an outlet for discharging the particulate organic material from said source! The retort has an external vessel and an inner vessel within the external vessel, whereby the walls of the two vessels are spaced apart from each other so as to define the external vessel interior space between the walls. The external vessel ulterior space is coupled to the source of the particulate organic material so as to allow gases to pass from said space to the source and the inner vessel has an inlet coupled to the source through which the particulate organic material can pass and an outlet for allowing the charcoal to exit the inner vessel.

The invention relates to a continuous charcoal manufacturing process and apparatus for turning organic material, such as wood and/or waste wood products, into charcoal.

### BACKGROUND OF INVENTION

Mankind has been making charcoal for thousands of years for use from organic material. Charcoal is the black/grey residue of impure carbon that is achieved by removing water and other volatile materials from organic material. Charcoal is mostly produced by slow pyrolysis, the heating of wood, sugar, bone char, or other organic materials/substances in the absence of oxygen which results in a soft, brittle, lightweight, black/grey, porous material containing approximately 60% to 75% carbon.

Production of wood charcoal where there is an abundance of wood has been going on since early civilisation. The production of wood charcoal was usually done by piling the pieces of wood on their ends to form a conical shape that had openings at the bottom to allow air to be admitted to a centrally formed flue within the conical pile. Then the whole pile was covered with a turf or moistened clay and then fired at the bottom. The firing would gradually spread outwards and upwards. Using this method, for 100 parts of wood a yield of about 15 to 20 parts by volume of charcoal was able to be produced.

The modern process of forming charcoal from wood is now carried out in ovens/retorts. These modern processes not only produce charcoal but they are also able to recover valuable by-products such as wood spirit, pyroligneous acid, wood tar, etc. The controlling of the temperature in this modern carbonizing process is very important because wood becomes brown at 220° C., a deep brown-black after some time at 280° C., and an easily powdered mass at 310° C. Charcoal made at 300° is brown, soft and friable, and readily inflames at 380° C. whereas charcoal made at higher temperatures it is hard and brittle, and does not fire until heated to about 700° C.

In the past century, there have been advances in charcoal producing processes which have resulted in the ability to produce a charcoal product containing less impurities and volatiles. The utilisation of rotary kilns, multiple hearth furnaces, fluidized bed reactors, vertical retorts, gasifiers, etc, has achieved improved charcoal yields and it has been possible to produce activated charcoal using high temperatures in a non-oxidizing or partially-oxidizing environment. However, such systems and processes are typically costly and require much energy. Moreover, many such systems and processes are still unable to yield desired quantities of high quality charcoal. The current known methods and apparatus for producing charcoal are usually permanent structures (not easily transportable) and use batch processing.

### OBJECT OF THE INVENTION

It is an object of the invention to provide a continuous charcoal manufacturing process and apparatus that overcomes or at least ameliorates at least some of the disadvantages and/or limitations of the known art, or at least provide the public with a useful choice.

### SUMMARY OF INVENTION

In a first aspect the invention resides a continuous charcoal manufacturing apparatus for turning organic material, such as wood and/or waste wood products, into charcoal, the charcoal apparatus including:
a) a wood chipper including an inlet for receiving wood to be chipped, a chipping blade and an outlet for discharging the wood chips from the wood chipper;
b) the retort having an external vessel and an inner vessel within the external vessel whereby the walls of the two vessels are spaced apart from another defining a external vessel interior space in which heated gases are adapted to circulate and flow around the exterior of the inner vessel and to the wood chipper;
c) a charcoal hopper situated below the outlet of the inner vessel to receive formed charcoal exiting through the outlet; and
d) a discharging means having a discharging inlet situated adjacent the hopper, a conveyor adapted to convey formed charcoal from the hopper to a discharging outlet situated downstream from the discharging inlet;
   wherein the charcoal apparatus is adapted to continuously form charcoal from wood material chipped in the wood chipper as a result of and in combination with heated exhaust gases and a pressure differential that is created by the heated exhaust gases flowing into the wood chipper so that a resultant mixture of wood chips and exhaust gases entering into the inner vessel is separated such that the wood chips fall under the action of gravity toward the inner vessel outlet passing through increasing temperature zones to form into charcoal by the time it exits the inner outlet and discharged therefrom by the discharging means.

In a second aspect the invention resides a continuous charcoal manufacturing apparatus for turning organic material, such as wood and/or waste wood material, into charcoal, the charcoal apparatus including:
a) a wood chipper including an inlet for receiving wood to be chipped, a chipping blade and an outlet for discharging the wood chips from the wood chipper;
b) the retort having an external vessel and an inner vessel within the external vessel whereby the walls of the two vessels are spaced apart from another defining a external vessel interior space in which heated gases are adapted to circulate and flow around the exterior of the inner vessel and to the wood chipper;
   i. the inner vessel having an inlet in the upper region of the inner vessel to allow wood chips to be received from the wood chipper via a first conduit connected at one end to the outlet of the wood chipper and connected at the other end to the inlet of the inner vessel;
   ii. the inner vessel having an outlet in the lower region of the inner vessel adapted to allow the charcoal formed from the wood chips to exit the inner vessel on the inner vessel and thus from the retort;
   iii. the external vessel has burner situated in a lower region of the external vessel wherein the burner is adjacent to the outlet of the inner vessel such that the burner is adapted to create a flame zone in the lower region of the interior space of the external vessel and that is adjacent to a lower region of the wall of the inner vessel in order to heat the interior of the inner vessel;
   iv. the external vessel has a first outlet in the upper region of the external vessel wherein the first outlet is adapted to vent heated exhaust gases created from the burner to the atmosphere;
   v. the external vessel has a second outlet in the upper region of the external vessel wherein the second outlet is connected to one end of a second conduit that is connected at the other end to the wood chipper adjacent to or in the region of the outlet of the wood chipper such that heated exhaust gases are able to flow from within the interior space of the external vessel through the second conduit and into the wood chipper in order to mix with and to assist in imparting motive flow to the wood chips so that the resultant mixture of woodchips and exhaust gases are able to flow through the first conduit and into the inner vessel;
c) a charcoal hopper situated below the outlet of the inner vessel to receive formed charcoal exiting through the outlet;
d) a discharging means having a discharging inlet situated adjacent the hopper, a conveyor adapted to convey formed charcoal from the hopper to a discharging outlet situated downstream from the discharging inlet;
wherein the charcoal apparatus is adapted to continuously form charcoal from wood material chipped in the wood chipper as a result of and in combination with the burner, heated exhaust gases and a pressure differential that is created by the heated exhaust gases flowing into the wood chipper so that resultant mixture of wood chips and exhaust gases entering into the inner vessel is separated such that the wood chips fall under the action of gravity toward the inner vessel outlet passing through increasing temperature zones to form into charcoal by the time it exits the inner outlet and discharged therefrom by the discharging means.

Optionally, the chipping blade is driven by an electric or petrol or diesel or gas powered motor.

Optionally, the wood chipper has an inlet situated adjacent and/or below the outlet of the wood chipper, wherein the inlet is connected to the second conduit such that heated exhaust gases from the exterior interior space are able to flow into the wood chipper and out the outlet of the wood chipper and through the first conduit and into the inner vessel.

Optionally, the retort has a stirring means adapted to stir the wood chips within the inner vessel and to assist in the egress of the formed charcoal from the inner vessel.

Optionally, the stirrer consists of a stirring blade situated within the inner vessel, a shaft having one end attached to the blade and the other end to a drive means situated outside the inner vessel such that the shaft extends from within the inner vessel and through the inner vessels outlet to the drive means.

Optionally, the shaft has a transverse extending paddle situated on the portion of the shaft that is outside the inner vessel, but is within the hopper, wherein the paddle is adapted to assist in pushing the formed charcoal from the hopper into the inlet of the discharging means and also to prevent clogging of the hopper.

Optionally, the first outlet of the external vessel is situated at the top of the external vessel and includes a venturi in order to allow heated exhaust gases to be vented to atmosphere.

Optionally, the venturi extends into the top portion of the inner vessel to allow exhaust gases separated from the wood chips to be vent to the atmosphere.

Optionally, the drive means is an electric or petrol or diesel or gas powered motor.

Optionally, the resultant mixture of wood chips and exhaust gases enter the inner vessel in cyclonic motion such that the cyclonic motion assists in separating the wood chips from the exhaust gases.

Optionally, the wood chips are heated up to about 700 C in the inner vessel.

Optionally, the burner is a gas fired burner.

Optionally, the gas is a synthesis gas.

Optionally., the burner includes an air duct in order to feed air to the burner.

Optionally, the gases given off by the heating of the wood chips is drawn downwards toward the burner by negative pressure created by an induction flow and pressure differential created by the exhaust gases and the venturi.

Optionally, the burner creates a flame zone that extends fully around the exterior circumference of the lower region of the inner vessel and the exhaust gases given off by the burner are adapted to circulate around and up the exterior sides of the inner vessel toward the first and second outlets, such that exhaust gases heat the sides of the inner vessel which in turn heats the interior of the inner vessel which in turn heats the wood chips as they pass through the inner vessel.

Optionally, the discharge means is screw conveyor.

Optionally the screw conveyor is angled upward relative to the retort wherein the discharge outlet is situated upper end of the screw conveyor and the inlet is situated at the lower end adjacent an outlet from the hopper.

Optionally, the screw conveyor is driven by an electric or petrol or diesel or gas powered motor.

Optionally, the first outlet includes a catalyst adapted to reduce the toxicity of emissions from the exhaust gases before the exhaust gases are vented to the atmosphere

Optionally the air duct includes an air manifold in order to deliver a constant and efficient supply of air to the burner.

In a third aspect the invention resides a charcoal manufacturing process for turning organic material, such as wood and/or waste wood material, into charcoal, the process includes
a) feeding wood into a wood chipper through an inlet to a chipping blade to produce wood chip that is forced through a wood chipping outlet for discharging the wood chips from the wood chipper;
b) feeding the wood chips to the inner vessel of a retort as a result of a pressure differential being created by the flow heated exhaust gases from a burner in an interior space Of an external vessel being feed into the wood chipper such that the flow of heated gases mix with and impart motive flow to the wood chips so that a resultant mixture of wood chips and exhaust gases are fed into the inner vessel of a retort consisting of the external and inner vessels, the inner vessel being situated within the external vessel whereby the walls of the two vessels are spaced apart from another defining the external vessel interior space in which heated gases are adapted to circulate and flow around the exterior of the inner vessel and into the wood chipper;
c) allowing the wood chips to fall under gravity toward an outlet of the inner vessel and in so doing passes through increasing temperature zones such that by the time the wood chips exit the inner vessel they are formed into charcoal; and
d) discharging the formed charcoal from the outlet of the inner vessel by a discharging means having a discharging inlet situated below an outlet of the inner vessel, a conveyor adapted to convey formed charcoal from the discharging to a discharging outlet situated downstream from the discharging inlet.

The process of the third aspect may use the apparatus of the first aspect, or the apparatus of the second aspect, or the apparatus of the fourth aspect.

In a fourth aspect of the invention there is provided a continuous charcoal manufacturing apparatus for turning particulate organic material into charcoal, said apparatus comprising:
a) a source of the particulate organic material, said source comprising an outlet for discharging the particulate organic material from said source;
b) a retort having an external vessel and an inner vessel within the external vessel, whereby the walls of the two vessels are spaced apart from each other so as to define a external vessel interior space between said walls, said external vessel interior space being coupled to the source so as to allow gases to pass from said space to the source and said inner vessel having an inlet coupled to the source through which the particulate organic material can pass and an outlet for allowing the charcoal to exit the inner vessel;
c) a heating device for heating gas in the external vessel interior space.

The following options may be used in conjunction with the fourth aspect, either individually or in any suitable combination.

The particulate organic material may comprise, or may be, wood chips, whereby the apparatus is adapted for turning said wood chips into charcoal. In this case, the source of the particulate organic material (i.e. of the wood chips) may be a hopper for containing wood chips or it may be a wood chipper. The wood chipper may comprise an inlet for receiving wood to be chipped, a chipping blade and an outlet for discharging wood chips from the wood chipper to the inner vessel.

The source of particulate organic material may be disposed above the inner vessel so as to allow the particulate, organic material to enter the inner vessel under gravity. Alternatively the gases which pass from the external vessel interior space to the source of the particulate organic material may assist in transporting the particulate organic material from the source to the inner vessel. The source may be coupled to the inner vessel by a first conduit to allow the particulate organic material to pass from the source to the inner vessel. The first conduit may be disposed so that the particulate organic material enters the inner vessel in a cyclonic motion.

The inner vessel may comprise a stirrer for stirring the particulate organic material and the charcoal formed in the inner vessel. The stirrer may comprise a stirring paddle. It may comprise a shaft coupled to a drive motor for driving the stirrer. The drive motor may be located outside the external vessel, whereby the shaft extends from inside the inner vessel to the drive motor.

The heating device may comprise a burner. It may be a gas fired burner. It may be a synthesis gas (“syngas”) fired burner. The apparatus may comprise a source of the synthesis gas. The source of the synthesis gas may be coupled to the burner so as to supply the synthesis gas to the burner. The apparatus may comprise an air duct for supplying air to the burner. The air duct may comprise a filter for preventing unwanted materials e.g. particulate materials, from passing to the burner. The heating device may be disposed so as to be capable of heating gas in the external’ vessel interior space. It may be disposed in the external vessel interior space or it may be disposed below the external vessel interior space. It may be disposed adjacent (optionally in contact with) to a lower region of the wall of the inner vessel in order to heat the interior of the inner vessel. It may be disposed so as to heat an external wall of the inner vessel. The heating device may be such that it can heat the particulate organic material in the inner vessel to a temperature of at least about 600° C., or at least about 700° C., or to a temperature of about 700° C.

The external vessel may have a first outlet, optionally in the upper region thereof, said first outlet being adapted to vent heated exhaust gases created from the heating device to the atmosphere. The first outlet may be, or may comprise, a venturi. It may be fitted with a scrubber, a filter or some other device (or a combination of any two or more of these) for removing from the exhaust gases materials which are undesirable to vent to atmosphere. It may comprise a catalyst for deactivating such materials. The external vessel may have a second outlet, optionally in the upper region thereof, said second outlet being connected to one end of a second conduit that is connected at the other end to the source of the particulate organic material so as to allow heated exhaust gases to flow from the interior space of the external vessel through the second conduit and into the source of the particulate organic material in order to mix with, and to assist in imparting motive flow to, the particulate organic material so as to propel or transport said particulate organic material into the inner vessel. The inner vessel may be coupled to the second conduit so as to allow exhaust gases from the inner vessel to pass into the source together with the heated exhaust gases from the interior space of the external vessel.

The apparatus may additionally comprise a charcoal hopper situated below the outlet of the inner vessel to receive charcoal exiting through the outlet.

The apparatus may additionally comprise a discharging means having a discharging inlet situated adjacent the hopper, a conveyor adapted to convey formed charcoal from the hopper to a discharging outlet situated downstream from the discharging inlet. The conveyor may comprise a screw thread for transporting the charcoal. In the event that the apparatus comprises a stirrer having a shaft extending to a drive motor located outside the external vessel, the shaft may have a paddle for assisting the charcoal to move from the hopper to the discharging means.

The apparatus may additionally comprise a treating device for treating the charcoal after it has exited from the outlet of the inner vessel. The treating device may comprise a container for a treating substance and a conduit for conducting the treating substance to a treatment location where it is combined (e.g. mixed, stirred etc.) with the charcoal so as to treat the charcoal. The treatment location may be within the charcoal hopper (if present). It may be within the discharging means (if present). The treatment location may be such that there is sufficient time before the charcoal leaves the apparatus for effectively treatment of the charcoal.

The apparatus may be transportable. It may be for example fitted with wheels for transportation, or it may be mounted on a wheeled vehicle (e.g. a trolley, barrow, carriage etc.) or it may be mountable on a wheeled vehicle. It may be suitable (e.g. sufficiently light and compact) so as to be transportable. It may be transportable by rail. It may be transportable by road. It may be transportable by aeroplane.

In an embodiment, there is provided a continuous charcoal manufacturing apparatus for turning wood chips into charcoal, said apparatus comprising:
a) a wood chipper for chipping wood to produce the wood chips, said wood chipper comprising an outlet for discharging the wood chips from said wood chipper;
b) the retort having an external vessel and an inner vessel within the external vessel, whereby the walls of the two vessels are spaced apart from each other so as to define a external vessel interior space between said walls, said external vessel interior space being coupled to the wood chipper so as to allow gases to pass from said space to the wood chipper and said inner vessel having an inlet coupled to the wood chipper through which the wood chips can pass and an outlet for allowing the charcoal to exit the inner vessel;
c) a burner for heating gas in the external vessel interior space, said burner being disposed adjacent to a lower region of the wall of the inner vessel in order to heat the interior of the inner vessel;
d) a charcoal hopper situated below the outlet of the inner vessel to receive charcoal exiting through the outlet; and
e) a discharging means having a discharging inlet situated adjacent the hopper, a conveyor adapted to convey formed charcoal from the hopper to a discharging outlet situated downstream from the discharging inlet.

In another embodiment, there is provided a continuous charcoal manufacturing apparatus for turning wood chips into charcoal, said apparatus comprising:
a) a wood chipper for chipping wood to produce the wood chips, said wood chipper comprising an outlet for discharging the wood chips from said wood chipper;
b) the retort having an external vessel and an inner vessel within the external vessel, whereby the walls of the two vessels are spaced apart from each other so as to define a external vessel interior space between said walls, said external vessel interior space being coupled to the wood chipper so as to allow gases to pass from said space to the wood chipper and said inner vessel having an inlet coupled to the wood chipper through which the wood chips can pass and an outlet for allowing the charcoal to exit the inner vessel;
c) a burner for heating gas in the external vessel interior space, said burner being disposed adjacent to a lower region of the wall of the inner vessel in order to heat the interior of the inner vessel;
d) a charcoal hopper situated below the outlet of the inner vessel to receive charcoal exiting through the outlet;
e) a discharging means having a discharging inlet situated adjacent the hopper, a conveyor adapted to convey formed charcoal from the hopper to a discharging outlet situated downstream from the discharging inlet; and
f) a treating device for treating the charcoal, said treating device comprising a container for a treating substance and a conduit for conducting the treating substance to a treatment location within the discharging means.

It will be recognised that the first and second aspects may be regarded as particular embodiments of the fourth aspect.

In a fifth aspect of the invention there is provided a charcoal manufacturing process for turning particulate organic material into charcoal, the process comprising:
a) providing the particulate organic material in a source of said particulate organic material;
b) heating gases within an external vessel interior space of a retort, said space being defined by an inner vessel and an external vessel of said retort which are spaced apart from each so as to define said external vessel interior space, said space being coupled to the source of the particulate organic material so as to allow heated gases from said external vessel interior space to pass to said source;
c) passing heated gases from external vessel interior space to the source of the particulate organic material;
d) feeding the particulate organic material from the source thereof, together with the heated gases from the external vessel interior space, to the inner vessel;
e) allowing the particulate organic material to pass through the inner vessel to an outlet of said inner vessel for sufficient time for said particulate organic material to be converted to charcoal; and
f) allowing the charcoal to pass out of the outlet of the inner vessel.

The process may additionally comprise discharging the charcoal from the outlet of the inner vessel by a discharging means. The discharging means may have a discharging inlet situated below an outlet of the inner vessel, a conveyor being adapted to convey formed charcoal from the discharging inlet to a discharging outlet situated downstream from the discharging inlet. The conveyor may comprise a screw thread, whereby the discharging may comprise rotating the screw thread in a direction so as to discharge the charcoal through the discharging outlet. The process may comprise passing the charcoal from the outlet of the inner vessel to a hopper. It may comprise discharging the charcoal from said hopper by means of the discharging means.

The process may comprise passing exhaust gases from the inner vessel into the source together with the heated exhaust gases from the interior space of the external vessel.

If the source of the particulate organic material is a hopper, the step of providing the particulate organic material may comprise loading said material into the hopper. The particulate organic material may comprise, or may be, wood chips. In this case the source of the particulate organic material may be a hopper or a wood chipper. If the source is a wood chipper, then the step of providing the particulate organic material may comprise feeding wood to said wood chipper and operating the wood chipper so as to produce the wood chips.

The process may comprise treating the charcoal after it has exited from the outlet of the inner vessel. The step of treating may comprise conducting a treating substance to a treatment location and combining said treating substance with the charcoal so as to treat the charcoal. The treating substance may comprise clay, smoke chemicals, other organic chemicals, treating inorganic acids or bases, treating minerals or a combination of any two or more of these. The treating may comprise allowing sufficient time after combining the treating substance with the charcoal for effectively complete treatment of the charcoal.

The process may be a continuous process, whereby the particulate organic material is continuously fed to the inner vessel of the retort and charcoal is continuously discharged from the outlet of the inner vessel.

The process of the fifth aspect may use the apparatus of the fourth aspect, or the apparatus of the first aspect or the apparatus of the second aspect.

In an embodiment there is provided a charcoal manufacturing process for turning wood chips into charcoal, the process comprising:
a) feeding wood to a wood chipper and operating the wood chipper so as to produce the wood chips;
b) heating gases within an external vessel interior space of a retort, said space being defined by an inner vessel and an external vessel of said retort which are spaced apart from each so as to define said external vessel interior space, said space being coupled to the wood chipper so as to allow heated gases from said external vessel interior space to pass to said source;
c) passing heated gases from external vessel interior space to the wood chipper;
d) feeding the wood chips from the wood chipper, together with the heated gases from the external vessel interior space, to the inner vessel;
e) allowing the wood chips to pass through the inner vessel to an outlet of said inner vessel for sufficient time for said wood chips to be converted to charcoal;
f) allowing the charcoal to pass out of the outlet of the inner vessel;
g) passing the charcoal from the outlet of the inner vessel to a hopper; and
h) discharging the charcoal from the hopper by means of a discharging means having a discharging inlet situated below an outlet of the inner vessel, a conveyor being adapted to convey formed charcoal from the discharging inlet to a discharging outlet situated downstream from the discharging inlet.

The process of the fifth aspect may use the apparatus of the fourth aspect. It will be recognised that the third aspects may be regarded as a particular embodiment of the fifth aspect.

### DETAILED DESCRIPTION

The present invention relates to a device for producing charcoal and to a process for producing charcoal.

The particulate organic material used in the present invention is commonly wood chips, however any other suitable organic material may be used that will generate charcoal on exposure to heat. It may for example be dried banana tree trunks, peat, nut shells or other organic matter of suitable size (about 1 to about 15 mm mean diameter) and consistency, or may be a combination of any two or more suitable materials.

The charcoal is produced in a retort, which comprises an external vessel and an inner vessel which are spaced apart so as to define an external vessel interior space between the inner wall of the external vessel and the external wall of the inner vessel. In the context of the present specification, the term “retort” is used simply to refer to a vessel used for conducting a chemical reaction, in the present case, conversion of organic matter to charcoal.

The external and inner vessels are commonly the same or similar shape, although there is no requirement for this to be the case. The inner, vessel may be tapered towards its lower end so as to direct the charcoal to the outlet from the inner vessel. The inner vessel and the external vessel may, independently, be approximately a sphere, an ovoid, a bipyramid, an elongated bipyramid (the bipyramids having any suitable number of parallel faces, e.g. 3, 4, 5, 6, 7, 8, 9, 10, 11 or 12 or more than 12) etc. Commonly the vertical axes of the external and inner vessels will be coincident although this is not necessarily the case. The volume of the inner vessel will to some extent control the throughput of the apparatus. The volume may be between about 0.1 and about 5 m³, or about 0.1 to 1, 0.1 to 0.5, 0.5 to 5, 0.5 to 2 or 1 to 5 m³, e.g. about 0.1, 0.2, 0.3, 0.4, 0.5, 0.6, 0.7, 0.8, 0.9, 1, 1.5, 2, 2.5, 3, 3.5, 4, 4.5 or 5 m³. The distance between the inner and external vessels (i.e. the width of the external vessel interior space) may be approximately uniform or may vary. It may average about 1 to about 10 cm or about 1 to 5, 5 to 10 cm, e.g. about 1, 2, 3, 4, 5, 6, 7, 8, 9, 10 cm. This distance will depend to some degree on the size of the vessels. When the vessels are relatively large the apparatus may be a production apparatus, and when they are relatively small it may be a pilot scale or laboratory scale apparatus.

The apparatus has a heating device for heating gases within the external vessel interior space. Commonly this is a burner, although other heating devices, for example an electrical heater, a heat exchange tube etc. may also be used. Suitable burners use synthesis gas, although again other fuels such as liquid or solid hydrocarbon fuels may also be used. The heating device is disposed so as to heat the gases within the external vessel interior space. It may be disposed in the external vessel interior space, commonly at or near the lower end thereof. The heated gases may then heat the inner vessel, so as to heat the inner region thereof. This is necessary so as to heat the particulate organic matter in the inner vessel and convert it to charcoal. The heating device may be disposed so as to also heat the inner vessel directly (by heating the external wall thereof), thereby supplementing the, heating effect of the heated gases in the external vessel interior space. It may therefore be disposed in contact with or near the lower end of the inner vessel. Thus the heating device may take the form of a ring burner surrounding a lower end of the inner vessel, or it may take the form of electrical heating coils abutting or near the lower end of the inner vessel. In the event that the heating device is a burner, there may be an air duct in order to feed air to the burner. There may also be a fuel line to feed fuel (e.g. combustible gas) to the burner. The apparatus may have a thermometer (which term encompasses all manner of temperature measuring devices) for determining a temperature in the inner vessel. This may be disposed so as to determine a temperature at a lower end of the vessel. The thermometer may provide feedback to a heating device controller so as to maintain the temperature in the inner vessel at a desired level or within a desired range. Suitable target temperatures in the lower region of the inner vessel are commonly about 600 to about 800° C., or about 600-700, 700 to 800 or 650-750° C., e.g. about 600, 650, 600, 750 or 800° C.

The external vessel may be insulated to prevent or restrict loss of heat energy. Suitable insulating materials are well known and include ceramics, asbestos etc.

The apparatus also comprises a source of the particulate organic material. This source may simply be (or comprise) a hopper for containing the material. The hopper may be sufficiently large that a continuous run of charcoal manufacture can be conducted from a single hopper load, or it may be designed so as to accept particulate organic material during a continuous run so that it may be topped up while the apparatus is running, so as to ensure that there is a steady supply of the particulate organic material to the retort. Alternatively the source may generate the particulate organic material, for example by crushing, shredding, cutting, slicing, chipping, grinding or otherwise comminuting the organic material. Thus the source may comprise a crusher, a shredder, a cutter, a slicer, a chipper, a grinder or some other device, or may comprise more than one of these. The particulate organic material may have a mean particle diameter of about 1 to about 15 mm, or about 1 to 10, 1 to 5, 5 to 10, 10 to 15 or 5 to 15 mm, e.g. about 1, 2, 3, 4, 5, 6, 7, 8, 9, 10, 11, 12, 13, 14 or 15 mm. In this context, the diameter may refer to a mean effective diameter, i.e. the diameter of a sphere having the same volume as the particle. The mean particle diameter may be a weight average or a number average mean. In general, the smaller the particles of the particulate organic material in the inner vessel, the more readily or rapidly they will be completely converted into charcoal, since the time taken for the insides of the particles to reach sufficient temperature for formation of charcoal will be shorter. The actual particles of the organic material may be irregular shaped or may be regular, e.g. spherical, cubic, polyhedral, acicular or some other shape. In a particular embodiment, the particulate organic matter comprises wood chips, whereby the source comprises a wood chipper. This may comprise a blade, for example a toothed blade, for producing wood chips from larger pieces of wood e.g. logs or branches. In the event that the source comprises a device for comminuting the organic material, there may also be a hopper for storing the particulate organic material (e.g. wood chips) once formed, or the particulate organic material may be fed directly to the retort.

The source of the particulate organic material is coupled to the external vessel interior space so that gases which have been heated by the heating device can pass to the source. This heated gas can serve one or more, optionally all, of the following purposes. Firstly it can preheat the particulate organic material, so that when it enters the inner vessel it is more rapidly heated to a temperature at which it converts to charcoal. This represents a means of improving the energy efficiency of the apparatus. Secondly it can assist in transporting the particulate organic material to the inner vessel. Additionally the heated gas can at least partially torrefy the particulate organic material prior to said material entering the inner vessel. Finally, the heated gas can at least partially dry the particulate organic material prior to said material entering the inner vessel. In general therefore, the heated gas can prepare the particulate organic material for conversion to charcoal in the inner vessel and can assist in transporting the particulate organic material to the inner vessel. Clearly the smaller the particles of the organic material, the lower the specific gravity of the organic material and the higher the flow rate of the heated gases, the more effectively the particulate organic matter will be transported to the inner vessel. In the event that the source comprises a chipper or similar for comminuting the organic material, the rotating blade of the chipper may impart kinetic energy to the particulate organic material as it forms, further assisting the transport into the inner vessel. In some cases the source is located above, or at least at a higher level than, the inner vessel, so that the transport of the particulate organic material is assisted by gravity. In other cases the source is located beside or at a lower level to the inner vessel in which case gravity will not assist. As the particulate organic material is heated in the inner vessel to form charcoal, it may evolve gases in the inner vessel. In any event the gases present in the inner vessel are heated by the heated gases circulating in the external vessel interior space, and also optionally by direct heating of the inner vessel by the heating device. The heated gases from the inner vessel (or at least a proportion thereof) may also be passed with the heated gases from the external vessel interior space to the source of the particulate organic material so as to further heat and/or transport the material to the inner vessel. Thus one conduit is present coupling the external vessel interior space to the source, for passing heated gases from the external vessel interior space and optionally also from the inner vessel to the source, and another conduit is present coupling the source to the inner vessel, for passing particulate organic material and heated gases from the source to the inner vessel. This conduit may be disposed at least partially tangentially to the inner vessel so that the particulate organic material moves within the inner vessel in a cyclonic motion, at least initially. This conduit commonly opens near an upper end of the inner vessel so that the particulate organic material moves downwards through the inner vessel towards the outlet. Since the heating of the inner vessel is greater at the lower end (where the heating device is located) it is considered that as the particulate organic material moves downwards through the inner vessel, it will move into progressively hotter regions, so that it will be progressively converted to charcoal, which process will be complete by the time that it exits through the outlet at or near the lower end of the inner vessel. The time required for the particulate organic material to pass through the inner vessel and be converted to charcoal may depend on various factors, such as the nature of the particulate organic material (including its moisture content, chemical nature etc.), the particle size of the particulate organic material, the temperature and temperature distribution within the inner vessel, the speed of stirring (if practiced) within the inner vessel, etc. The rate may be adjusted by means of a rate adjustor. This may take the form of a variable restrictor at the outlet of the inner vessel, which controls the rate of egress of charcoal from the inner vessel. Alternatively the rate may be fixed by the size of the outlet, whereby the apparatus may be most suitable for a particular type of particulate organic material. The rate of egress of the charcoal from the inner vessel should be matched to the rate of ingress of particulate organic material to the inner vessel. This may be achieved by varying, for example, the rate of feed of wood to a wood chipper which represents the source of wood chips, or by varying the rate of egress from a hopper which contains the particulate organic material.

The inner vessel may be fitted with a stirrer for agitating or stirring the particulate organic material and the forming charcoal within the inner vessel. This promotes a relatively even exposure of the particles to heat so that all particles will be converted approximately uniformly to charcoal. The stirrer is commonly driven by a motor which is outside the retort and is coupled to a stirrer blade by a shaft which passes through the outlet of the retort. The stirrer may also assist in controlling the rate of egress of charcoal from the outlet of the inner vessel. It may therefore be used to at least partially control the residence time of the particulate organic material in the inner vessel.

The external vessel may be vented, commonly near the top of the vessel, so as to allow any heated gases which do not pass to the source to exit from the retort. This avoids a dangerous build-up of pressure within the retort. The vent may be designed to prevent unwanted, e.g. hazardous, materials from exiting the apparatus into the atmosphere. It may comprise a filter or electrostatic precipitator so as to prevent fine particulates from exiting. It may comprise a catalytic converter so as to prevent toxic materials from exiting. The vented gases may pass through a heat exchanger prior to venting to the atmosphere, so as to recover heat energy from said gases. The heat energy recovered from the gases may be used in the process (e.g. to preheat the particulate organic material) or may be used for other purposes (e.g. for generation of electricity, which may in turn be used in the process of-the invention).

It will be appreciated that heating organic matter in the presence of sufficient oxygen can cause combustion. This is undesirable in the present case. Thus the gases may be relatively low in oxygen. They may be sufficiently low that, under the conditions used in the process, the particulate organic matter does not combust. In the event that a burner is used as a heating device in the retort, the burner may consume sufficient oxygen to inhibit combustion. As the heater heats the gases in the external vessel interior space, these gases will be low in oxygen. As described above, these gases are passed to the source of the particulate organic material and thence to the inner vessel. Thus the burner can deplete the inner vessel of oxygen so that the heated organic matter does not combust. In the event that the heating device is not a burner, other means may be used to deplete the gases of oxygen. These may comprise use of an oxygen absorber, or feeding anoxic or low oxygen content gas to the inner vessel and/or to the external vessel interior space. Suitable such gases include nitrogen, steam, carbon dioxide, helium, argon and combinations of these.

The charcoal produced as described above may be treated with various treating agents. This may comprise surface treatment or some other treatment, or may comprise both surface treatment and some other treatment. Suitable treating agents include clay, smoke chemicals, other organic chemicals, treating inorganic acids or bases, treating minerals or a combination of any two or more of these. Suitable organic chemicals include nitrogen containing polymer, a butenolide, salicylic acid, chitin and/or chitosan. These may make the resulting treated charcoal more suitable for use in agricultural purposes, e.g. for promoting crop growth. Smoke chemicals are given off by the action of heat on certain organic materials, and may comprise aromatic and/or aliphatic compounds. There may be various carbonyl and/or carboxylic compounds such as aldehydes, ketones and carboxylic acids in the smoke chemicals.

Thus a representative process for producing charcoal using the present invention involves heating the inner vessel of the retort by means, for example of a ring burner located around its lower end. The heated gases from the external vessel, and also from the inner vessel, are passed to a wood chipper. Any excess heated gases are vented to the atmosphere, optionally after scrubbing to remove or reduce toxic materials. The wood chipper is fed with wood so as to produce wood chips, which are passed under the momentum gained from the wood chipping process together with the heated gases returned from the two vessels into the inner vessel. The heating of the inner vessel, in part from the heated gases circulating through the external vessel inner space and in part from direct heating of the inner vessel from the burner, causes the wood chips to convert to charcoal as they pass downwards through the vessel. Agitation of the wood chips as they convert to charcoal within the inner vessel ensures that the wood chips receive even heating so that all chips are converted to charcoal and none are overheated. As the charcoal exits the bottom end of the inner vessel, it is conveyed to a discharging means. The charcoal discharged from the apparatus through the discharging means may be bagged or otherwise packaged for future use, or may be directly transported to a separate location for use, e.g. by rail.

The apparatus and method described herein may be capable of producing charcoal at a rate of anywhere between about 0.01 and about 10 m³/h or between about 0.1 and 10, 1 and 10, 0.1 and 1 or 0.5 and 5 m³/h, e.g. about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9 or 10 m³/h. The output will depend on the rate of input of particulate organic material and on the size of the apparatus.

### BRIEF DESCRIPTION OF THE DRAWING

The invention will now be described, by way of example only, by reference to the accompanying drawing:

FIG. 1 is a diagrammatic view charcoal producing apparatus in accordance with an embodiment of the invention.

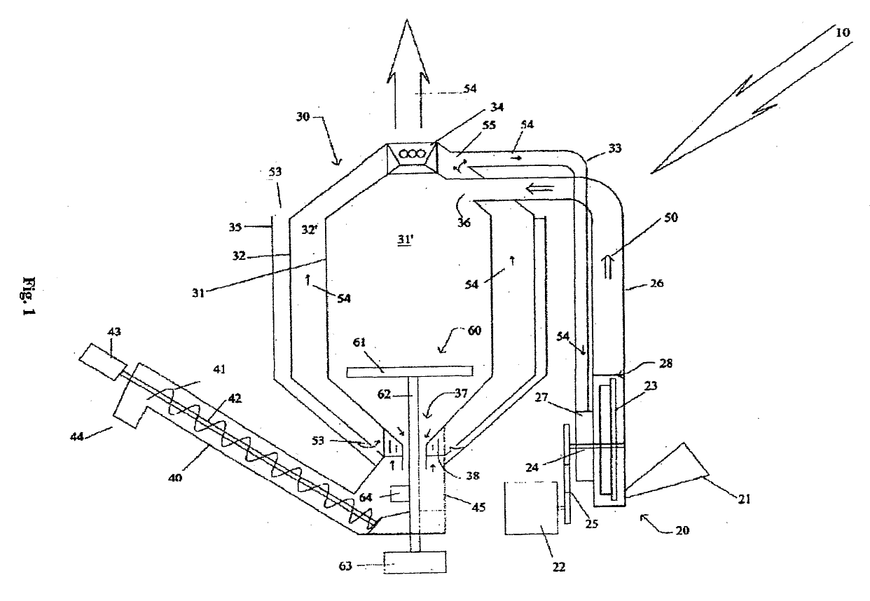

### DESCRIPTION OF DRAWINGS

The following description will describe the invention in relation to embodiments of the invention, namely a continuous charcoal manufacturing process and apparatus for turning organic material, such as wood and/or waste wood products, into charcoal. The invention is in no way limited to these embodiments as they are purely to exemplify the invention only and that possible variations and modifications would be readily apparent without departing from the scope of the invention.

The charcoal producer 10 is a continuous process from preparation of the wood into suitable form, to charcoal forming and to the dispensing/bagging/packaging of the charcoal. The charcoal producer 10 is compact which makes it easy to transport, thus allowing for the charcoal producer 10 to be used ‘onsite’ where there is a supply of wood or waste wood product (e.g. forests, timber processing yards, etc). Thus charcoal is able to produced and bagged onsite in one continuous process.

The charcoal producer 10 consists of three major interrelated components, these being the wood chipper 20, vertical retort 30 and discharge conveyor 40. The wood chipper 20 is connected to the retort 30 so that wood chipper and the exhaust gases 54 from the retort provide motive flow 50 to the wood chips to provide the required pressure differential to allow process of forming charcoal to function. The wood chipper 20 as shown in the drawing consists of wood inlet feed 21 opening into an interior chipping region 27 that includes a circular chipping blade 23 mounted on a rotatable shaft 24 connected to a drive chain 25 connected to a motor 22. The motor is typically petrol driven motor, however any other known motive power is envisaged including a diesel motor or an electric motor or gas powered motor. Chipped wood exits from the wood chipper through an outlet 28 connected to a conduit 26.

The conduit 26 extends from the wood chipper to an upper region of an inner vessel 31 of the retort 30 where it is connected to an inlet 36. The conduit transfers a mixture of wood chips and exhaust gases 54 from the wood chipper to the interior 31′ of the inner vessel.

The retort 30 consists of an external vessel 32 and an inner vessel 31 within the external vessel 32. The walls of the two vessels are spaced apart from one another to define an external vessel interior space 32′ in which heated gases 54 are ‘adapted, or able, to circulate and flow around the exterior of the inner vessel and into the chipping region 27 of the wood chipper 20 via conduit 33.

The inner vessel has an interior space 31’ and as an inlet 36 for receiving a mixture of wood chips and exhausts gases 54 from the wood chipper via conduit 26. The inner vessel 31 has an outlet 37 in the lower region of the inner vessel. Formed charcoal is able to exit form the inner vessel 31 and into a hopper 45 that is connected and opens to a discharging conveyor 40.

The external vessel 32 has a burner 38 situated in a lower region of the external vessel 32 and the burner 38 is adjacent to the outlet 37 of the inner vessel 31. The burner 38 creates a flame zone in the lower region of the interior space 32′ of the external vessel 32 and where the flame zone is adjacent to a lower region of the wall of the inner vessel 31 so that indirect heating of the interior 31′ of the inner vessel 31 is able to take place. Further indirect heating of the interior 31′ of the inner vessel is achieved as the exhaust gases 54 circulate upwardly around the outside of the inner vessel. The temperature of the interior 31′ of the inner vessel 31 is at its greatest in the region directly opposite the flame zones and the burner. The highest temperature within the inner vessel is about 700° C. The burner 38 is a synthesis gases fired burner and the burner has an air duct 35 for supply air 53 to the burner 38 in order to combust with the synthesis gas to produce heat and heated exhaust gases 54. The burner 38 is configured and situated around the lower region of the exterior vessel 32 so that the flame zone created extends fully around the exterior circumference of the lower region of the inner vessel and the exhaust gases given off by the burner are able to circulate around and up the exterior sides of the inner vessel toward the first and second outlets, such that flame zone and exhaust gases heat the sides of the inner vessel which in turn heats the interior of the inner vessel which in turn heats the wood chips as they pass through the inner vessel in order to produce charcoal before exiting the inner vessel 31.

The external vessel 31 has two outlets situated in the upper region of the external vessel 31, one outlet 34 vents exhaust gases 54 to the atmosphere and the other outlet 55 is connected to one end of a conduit 33. The venting outlet 34 includes a venturi and the venturi extends in to the interior of the inner vessel 31 as well so that exhaust gases 54 within the inner vessel 31 can also be vented to the atmosphere when required. The other end of the conduit 33 is connected and opens in the chipping region of the wood chipper 20 adjacent and below the outlet 28 of the wood chipper 20 so that heated exhaust gases 54 from the interior space 32′ are able to flow in to the chipping region 27 and be mixed with the wood chips. The combination of the motion imparted to the wood chips from the rotating chipping blade 23 and the flow of the exhaust gases 54 provides sufficient motive flow 50 to the mixture of wood chips and exhaust gases to travel along the conduit 26 and into the interior 31′ of the inner vessel 31.

The combination of the wood chipper 20, the burner 38, and heated exhaust gases 54 creates a pressure differential that allows a cyclic flow from the burner into the interior space 32′, to the wood chipper and into the interior 31′ of the inner vessel and back to the burner 38.

The mixture of mixture of wood chips and exhaust gases entering into the inner vessel 31 are separated such that the wood chips fall under the action of gravity toward the inner vessel outlet 37 passing through increasing temperature zones as they do to form into charcoal by the time they exit the inner outlet 37 and discharged therefrom in to the hopper 45 and to the discharging conveyor 40. The configuration and arrangement of the inlet 36 is such that the mixture of wood chips and exhaust gases entering the inner vessel 31 are imparted with a cyclonic motion such that the cyclonic motion assists in separating the wood chips from the exhaust gases. The gases given off by the heating of the wood chips are drawn downwards toward the burner 38 by negative pressure created by an induction flow and pressure differential created by the flow exhaust gases and the venturi.

A stirrer 60 extends into the interior 31 of the inner vessel so as to stir the wood chips as they are being formed in to charcoal. The stirrer 60 consists of a stirring blade 61 situated within the inner vessel 31, a shaft 62 having one end attached to the blade 61 and the other end to a drive motor 63 situated outside of the inner vessel 31. The shaft 62 extends from within the inner vessel 31, through the inner vessels outlet 37 and through the hopper 45 to the drive motor 63. The shaft 62 has a transverse extending paddle. 64 situated on the portion of the shaft 62 that is outside the inner vessel 31, but is within the hopper 45. The paddle 64 assists in pushing the formed charcoal from the hopper 45 on to the path of the screws 41 of the screw conveyor 40.

The screw conveyor 40 is angled upward such that the outlet 44 is situated at the upper end of the screw conveyor 40. The screw conveyors have screws 41 attached to a shaft 42 that is connected to a drive motor 43. In operation the screw conveyor 40 extracts formed charcoal form the hopper 45 where it is discharged from the screw conveyor via outlet 44. The charcoal can be discharged to from piles of charcoal or can be discharged directly into to bags or other suitable packaging.

The continuous charcoal producer 10 operates as follows:
a) feeding wood into a wood chipper 20 through an inlet 21 to a chipping blade 23 to produce wood chip that is forced through a wood chipping outlet 28;
b) the wood chip is feed to the inner vessel 31 of a retort 30 as a result of a pressure differential being created by the flow heated exhaust gases 54 from a burner 38 in to an interior space 32′ of an external vessel 32 and being feed into the wood chipper 20 such that the flow of heated gases 54 mix with and impart motive flow 50 to the wood chips so that a resultant mixture of wood chips and exhaust gases are feed into the inner vessel 31;
c) the wood chip falls under gravity toward the outlet 37 of the inner vessel 31 and in so doing passes through increasing temperature zones such that by the time the wood chips exit the inner vessel 31 they are formed into charcoal; and
d) the formed charcoal is discharged from the outlet 37 of the inner vessel 31 into a hopper 45 from which the charcoal is discharged to a screw conveyor.

The motive flow is a unique design modification to the wood chipper that to allows the induction of hot exhaust gases from the process into the wood chipper to provide the required pressure differential to allow process to function continuously. As the wood chips fall through the inner vessel 31 toward the outlet 37 they are heated up to around 700° C. which is sufficient for, charcoal to be produced.

At the top of the burner flame zone, the exhaust gas from the burner in the interior space 32′ can be split into two streams by a proportionating valve to regulated flow between the chipper and venturi.

The outlet 34 can include a catalyst to reduce the toxicity of emissions from the exhaust gases before the exhaust gases are vented to the atmosphere

The air duct 35 adjacent the burner 38 can include an air manifold in order to deliver a constant and efficient supply of air 53 to the burner 38.

### Advantages

a) a continuous flow process.
b) charcoal produced in an air free environment with the use of flooded exhaust gas instead of the use of valves.
c) one step process, from feed stock to finished product.

### Variations

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

1. A continuous charcoal manufacturing apparatus for turning particulate organic material into charcoal, said apparatus comprising:
a) a source of the particulate organic material, said source comprising an outlet for discharging the particulate organic material from said source;
b) a retort having an external vessel and an inner vessel within the external vessel, whereby the walls of the two vessels are spaced apart from each other so as to define a external vessel interior space between said walls, said external vessel interior space being coupled to the source so as to allow gases to pass from said space to the source and said inner vessel having an inlet coupled to the source through which the particulate organic material can pass and an outlet for allowing the charcoal to exit the inner vessel; and
c) a heating device for heating gas in the external vessel interior space.

2. The apparatus of claim 1 wherein the particulate organic material comprises wood chips, whereby said apparatus is adapted for turning said wood chips into charcoal.

3.-4. (canceled)

5. The apparatus of claim 1 wherein the wood chipper comprises an inlet for receiving wood to be chipped, a chipping blade and an outlet for discharging wood chips from the wood chipper to the inner vessel.

6. The apparatus of claim 1 wherein the source is coupled to the inner vessel by a first conduit to allow the particulate organic material to pass from the source to the inner vessel.

7. The apparatus of claim 6 wherein the first conduit is disposed so that the particulate organic material enters the inner vessel in a cyclonic motion.

8. The apparatus of claim 1 wherein the inner vessel comprises a stirrer for stirring the particulate organic material and the charcoal formed in the inner vessel.

9. The apparatus of claim 8 wherein the stirrer comprises a stirring paddle and a shaft coupled to a drive motor for driving the stirrer, said drive motor being located outside the external vessel, whereby the shaft extends from inside the inner vessel to the drive motor.

10. The apparatus of claim 1 wherein the heating device comprises a gas fired burner.

11. (canceled)

12. The apparatus of claim 1 wherein heating device is disposed so as to be capable of heating gas in the external vessel interior space.

13. (canceled)

14. The apparatus of claim 1 wherein the heating device is capable of heating the particulate organic material in the inner vessel to a temperature of at least about 600° C.

15. (canceled)

16. The apparatus of claim 1 wherein the external vessel has a second outlet connected to one end of a second conduit that is connected at the other end to the source of the particulate organic material so as to allow heated exhaust gases to flow from the external vessel interior space through the second conduit and into the source of the particulate organic material in order to mix with, and to assist in imparting motive flow to, the particulate organic material so as to propel or transport said particulate organic material into the inner vessel.

17. The apparatus of claim 16 wherein the inner vessel is coupled to the second conduit so as to allow exhaust gases from the inner vessel to pass into the source together with the heated exhaust gases from the external vessel interior space.

18. The apparatus of claim 1 additionally comprising a charcoal hopper situated below the outlet of the inner vessel to receive charcoal exiting through the outlet.

19. (canceled)

20. The apparatus of claim 1 comprising a stirrer having a shaft extending to a drive motor located outside the external vessel and a charcoal hopper situated below the outlet of the inner vessel to receive charcoal exiting through the outlet wherein the shaft has a paddle for assisting the charcoal to move from the hopper to the discharging means.

21. The apparatus of claim 1 additionally comprising a treating device for treating the charcoal after it has exited from the outlet of the inner vessel, said treating device comprising a container for a treating substance and a conduit for conducting the treating substance to a treatment location where it is combined with the charcoal so as to treat the charcoal.

22. The apparatus of claim 21 comprising a charcoal hopper situated below the outlet of the inner vessel to receive charcoal exiting through the outlet, wherein the treatment location is within said hopper.

23. The apparatus of claim 21 additionally comprising:
i. a charcoal hopper situated below the outlet of the inner vessel to receive charcoal exiting through the outlet, and
ii. a discharging means having a discharging inlet situated adjacent the hopper, a conveyor adapted to convey formed charcoal from the hopper to a discharging outlet situated downstream from the discharging inlet, v wherein the treatment location is within said discharging means.

24. A charcoal manufacturing process for turning particulate organic material into charcoal, the process comprising:
a) providing the particulate organic material in a source of said particulate organic material;
b) heating gases within an external vessel interior space of a retort, said space being defined by an inner vessel and an external vessel of said retort which are spaced apart from each so as to define said external vessel interior space, said space being coupled to the source of the particulate organic material so as to allow heated gases from said external vessel interior space to pass to said source;
c) passing heated gases from external vessel interior space to the source of the particulate organic material;
d) feeding the particulate organic material from the source thereof, together with, the heated gases from the external vessel interior space, to the inner vessel;
e) allowing the particulate organic material to pass through the inner vessel to an outlet of said inner vessel for sufficient time for said particulate organic material to be converted to charcoal; and
f) allowing the charcoal to pass out of the outlet of the inner vessel.

25. The process of claim 24 additionally comprising the step of discharging the charcoal from the outlet of the inner vessel by a discharging means having a discharging inlet situated below an outlet of the inner vessel and a conveyor being adapted to convey formed charcoal from the discharging to a discharging outlet situated downstream from the discharging inlet.

26. The process of claim 25 comprising passing the charcoal from the outlet of the inner vessel to a hopper and discharging the charcoal from said hopper by means of the discharging means.

27. The process of claim 24 comprising passing exhaust gases from the inner vessel into the source together with the heated exhaust gases from the interior space of the external vessel.

28. The process of claim 1 wherein the source of the particulate organic material is a hopper and the step of providing the particulate organic material comprises loading said material into the hopper.

29-34. (canceled)

35. A continuous charcoal manufacturing apparatus for turning organic material, such as wood and/or waste wood products, into charcoal, the charcoal apparatus including:
a) a wood, chipper including an inlet for receiving wood to be chipped, a chipping blade and an outlet for discharging the wood chips from the wood chipper;
b) the retort having an external vessel and an inner vessel within the external vessel whereby the walls of the two vessels are spaced apart from another defining a external vessel interior space in which heated gases are adapted to circulate and flow around the exterior of the inner vessel and to the wood chipper;
c) a charcoal hopper situated below the outlet of the inner vessel to receive formed charcoal exiting through the outlet;
d) a discharging means having a discharging inlet situated adjacent the hopper, a conveyor adapted to convey formed charcoal from the hopper to a discharging outlet situated downstream from the discharging inlet;
wherein the charcoal apparatus is adapted to continuously form charcoal from wood material chipped in the wood chipper as a result of and in combination with heated exhaust gases and a pressure differential that is created by the heated exhaust gases flowing into the wood chipper so that a resultant mixture of wood chips and exhaust gases entering into the inner vessel is separated such that the wood chips fall under the action of gravity toward the inner vessel outlet passing through increasing temperature zones to form into charcoal by the time it exits the inner outlet and discharged therefrom by the discharging means.

36. A continuous charcoal manufacturing apparatus for turning organic material, such as wood and/or waste wood material, into charcoal, the charcoal apparatus including:
a) a wood chipper including an inlet for receiving wood to be chipped, a chipping blade and an outlet for discharging the wood chips from the wood chipper; b) the retort having an external vessel and an inner vessel within the external vessel whereby the walls of the two vessels are spaced apart from another defining a external vessel interior space in which heated gases are adapted to circulate and flow around the exterior of the inner vessel and to the wood chipper;
i. the inner vessel having an inlet in the upper region of the inner vessel to allow wood chips to be received from the wood chipper via a first conduit connected at one end to the outlet of the wood chipper and connected at the other end to the inlet of the inner vessel;
ii. the inner vessel having an outlet in the lower region of the inner vessel adapted to allow the charcoal formed from the wood chips to exit the inner vessel on the inner vessel and thus from the retort;
iii. the external vessel has burner situated in a lower region of the external vessel wherein the burner is adjacent to the outlet of the inner vessel such that the burner is adapted to create a flame zone in the lower region of the interior space of the external vessel and that is adjacent to a lower region of the wall of the inner vessel in order to heat the interior of the inner vessel;
iv. the external vessel has a first outlet in the upper region of the external vessel wherein the first outlet is adapted to vent heated exhaust gases created from the burner to the atmosphere;
v. the external vessel has a second outlet in the upper region of the external vessel wherein the second outlet is connected to one end of a second conduit that is connected at the other end to the wood chipper adjacent to or in the region of the outlet of the wood chipper such that heated exhaust gases are able to flow from within the interior space of the external vessel through the second conduit and into the wood chipper in order to mix with and to assist in imparting motive flow, to the wood chips so that the resultant mixture of woodchips and exhaust gases are able to flow through the first conduit and into the inner vessel;
c) a charcoal hopper situated below the outlet of the inner vessel to receive formed charcoal exiting through the outlet;
d) a discharging means having a discharging inlet situated adjacent the hopper, a conveyor adapted to convey formed charcoal from the hopper to a discharging outlet situated downstream from the discharging inlet;
wherein the charcoal apparatus is adapted to continuously form charcoal from wood material chipped in the wood chipper as a result of and in combination with the burner, heated exhaust gases and a pressure differential that is created by the heated exhaust gases flowing into the wood chipper so that resultant mixture of wood chips and exhaust gases entering into the inner vessel is separated such that the wood chips fall under the action of gravity toward the inner vessel outlet passing through increasing temperature zones to form into charcoal by the time it exits the inner outlet and discharged therefrom by the discharging means.

37. A charcoal manufacturing process for turning organic material, such as wood and/or waste wood material, into charcoal, the process includes a) feeding wood into a wood chipper through an inlet to a chipping blade to produce wood chip that is forced through a wood chipping outlet for discharging the wood chips from the wood chipper;
b) the wood chip is feed to the inner vessel of a retort as a result of a pressure differential being created by the flow heated exhaust gases from a burner in an interior space of an external vessel being feed into the wood chipper such that the flow of heated gases mix with and impart motive flow to the wood chips so that a resultant mixture of wood chips and exhaust gases are feed into the inner vessel of a retort consisting of the external and inner vessels, the inner vessel being situated within the external vessel whereby the walls of the two vessels are spaced apart from another defining the external vessel interior space in which heated gases are adapted to circulate and flow around the exterior 6f the inner vessel and in to the wood chipper;
c) the wood chip falls under gravity toward an outlet of the inner vessel and in so doing passes through increasing temperature zones such that by the time the wood chips exit the inner vessel they are formed into charcoal; and
d) discharging the formed charcoal from the outlet of the inner vessel by a discharging means having a discharging inlet situated below an outlet of the inner vessel, a conveyor adapted to convey formed charcoal from the discharging to a discharging outlet situated downstream from the discharging inlet.
